(19) United States
(12) Patent Application Publication
(10) Pub. No.: US 2015/0201055 A1
(43) Pub. Date: Jul. 16, 2015

(54) TELEPHONE DIALING DEVICE AND METHOD FOR AUTOMATIC CONVERSION

(71) Applicant: MediaTek Singapore Pte. Ltd., Singapore (SG)

(72) Inventors: YAJUN LI, Beijing (CN); Chin-Ying HSIEH, New Taipei City (TW)

(21) Appl. No.: 14/594,375

(22) Filed: Jan. 12, 2015

(30) Foreign Application Priority Data
Jan. 13, 2014 (CN) 201410014059.6

(51) Int. Cl. H04M 1/274

(52) U.S. Cl. CPC H04M 1/274

(57) ABSTRACT

A telephone dialing method for automatic conversion is disclosed. The telephone dialing method is used in a call device. The method includes: receiving a subscriber number after the call device makes a call or answers the call corresponding to the subscriber number successfully; performing a conversion process for converting the subscriber number into a complete number; and storing the complete number corresponding to the subscriber.

### CROSS REFERENCE TO RELATED APPLICATIONS

The present application is based on, and claims priority from, China Patent Application No. 201410014059.6, filed on Jan. 13, 2014, the disclosure of which is hereby incorporated by reference herein in its entirety.

### BACKGROUND OF THE INVENTION

1. Field of the Invention

Aspects of the present invention relate generally to telephone dialing methods and devices for automatic conversion used in a call device, and more particularly, to telephone dialing methods and devices for automatic conversion which can automatically transfer a subscriber number according to a country code and an area code of a current location of the call device.

2. Description of the Related Art

With the development of international business activities, the number of business people working in many countries is also increasing rapidly. The business people communicate with other people in different countries by using an international telephone service when the business people do business in many countries.

Users can make or receive calls between countries by using an international telephone service to keep in touch with people in different countries without changing their phone number. However, coding rules for the phone number in foreign countries or cities are different from the coding rules in the local country, so errors can occur when the users dial international telephones. It might cause more inconvenience for the users.

An international phone number is composed of an international call prefix, a country code, an area code and a subscriber number. The international call prefix is used when making a call. When the user dials a phone number from a country to another country, he/she needs to use the international call prefix of the country and the country code of the other country. The area code is also known as a national destination code. It usually represents a specific geographic area. Therefore, a complete phone number is defined: the international call prefix-the country code-the area code-the subscriber number (where “-” is a delimiter for easy reading). For example, an international phone number is 01186-10-26XXXXXX) wherein 011 is the international call prefix of US, 86 is the country code of China, 10 is the area code of Beijing, and the subscriber number is 26XXXXXX, indicating that the international phone number is being dialed from the US to Beijing, China.

However, the international call prefix, the country code, the area code and so on are different because the countries where the users live and the countries the users want to connect to are different. Therefore, for international travelers, it is very difficult to make a call in a new country or area without any help. Thus, there is a need for a telephone dialing device and method that enables the user to dial a correct phone number in different countries or areas.

### BRIEF SUMMARY OF THE INVENTION

A detailed description is given in the following embodiments with reference to the accompanying drawings.

Telephone dialing devices and methods for automatic conversion are provided.

In one exemplary embodiment, the invention is directed to a telephone dialing device for automatic conversion. The telephone dialing device comprises an input unit, a processing unit and a subscriber information database. The input unit receives a subscriber number after a call device makes a call or answers the call corresponding to the subscriber number successfully. The processing unit is coupled to the input unit and performs a conversion process for converting the subscriber number into a complete number. The subscriber information database is coupled to the processing unit and is used for storing the complete number corresponding to the subscriber.

In one exemplary embodiment, the invention is directed to a telephone dialing method for automatic conversion. The telephone dialing method is used in a call device. The method comprises: receiving a subscriber number after the call device makes a call or answers the call corresponding to the subscriber number successfully; performing a conversion process for converting the subscriber number into a complete number; and storing the complete number corresponding to the subscriber.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a telephone dialing device for automatic conversion according to an embodiment of the present invention;

FIG. 2 is a telephone dialing device for automatic conversion according to another embodiment of the present invention;

FIG. 3 is a flow diagram illustrating a method for obtaining a complete number corresponding to a subscriber number according to one embodiment of the present invention;

FIGS. 4A˜4B are flow diagrams illustrating a method for checking and modifying a phone number dialed by a user according to one embodiment of the present invention; and

FIGS. 5A˜5E are schematic diagrams for producing a pop-up dialog box to request the user to confirm whether the dialed phone number is correct according to one exemplary embodiment of the present invention.

### DETAILED DESCRIPTION OF THE INVENTION

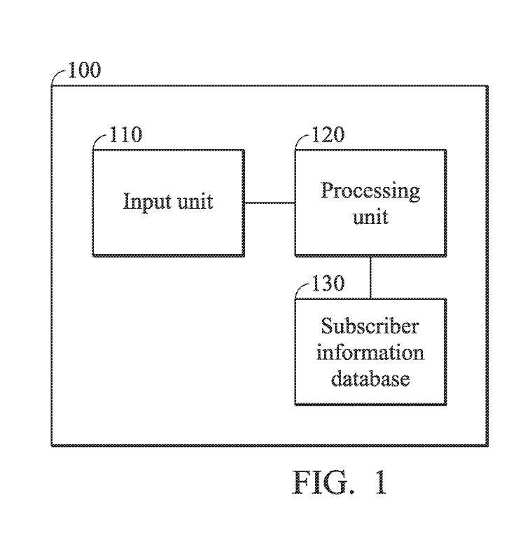

Several exemplary embodiments of present disclosure are described with reference to FIGS. 1 through 5E, which generally relate to a telephone dialing device and method for automatic conversion. It should be understood that the following disclosure provides various different embodiments as examples for implementing different features of the present disclosure. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

First, the present invention is divided into two main parts to explain: the first part is when a user successfully dials a subscriber number (wherein the subscriber number can be dialed through the contact list of a device directly, or through an input interface), or receives a call corresponding to the subscriber number, the device can employ a manner to obtain the country code and the area code of the subscriber number (if the subscriber number does not comprise the country code and/or the area code), transfer the subscriber number into a complete number and record it (the number recorded in the device can be called a “complete number”). In one embodiment, the complete number is not presented to the user. The second part is when the user dials a phone number, the device can automatically add the country code and/or the area code to the phone number, or modify the country code and/or the area code appropriately according to current information to help the user dial the phone number quickly and accurately if a complete number corresponding to the phone number has been stored in the device. Details are explained in the following description.

The First Part: Get a Complete Number Corresponding to the Subscriber Number

FIG. 1 is a telephone dialing device 100 for automatic conversion according to an embodiment of the present invention. The telephone dialing device 100 comprises an input unit 110, a processing unit 120 and a subscriber information database 130. The processing unit 120 is coupled to the input unit 110 and the subscriber information database 130. In addition, the telephone dialing device 100 in the present invention can be used in programmable touch screen phones, mobile phones, personal digital assistants (PDA) or other call devices with a dialing function.

After the user makes a call or answers the call corresponding to a subscriber number successfully by using the call device, the input unit 110 receives the subscriber number. The processing unit 120 performs a conversion process for converting the subscriber number into a complete number.

When the processing unit 120 receives the subscriber number from the input unit 110, the processing unit 120 determines whether the subscriber number comprises an international call identification symbol “+”. If the subscriber number comprises an international call identification symbol “+”, the processing unit 120 records the subscriber number as a complete number. If the subscriber number does not comprises an international call identification symbol “+”, the processing unit 120 employ a manner to obtain an country code and an area code for a current location of the call device, and determines whether the beginning of the subscriber number is an international call prefix corresponding to country code of the current location.

Wherein the acquisition manner can be that the processing unit 120 obtains current location information of the call device using a global positioning system (GPS) receiver, for example, which provides latitude and longitude coordinates information of the current location of the call device. Then, the processing unit 120 transfers the current location information to the country code and the area code of the current location.

In addition, the acquisition manner also can be that the processing unit 120 obtains current location information of the call device through a public land mobile-communication network (PLMN) and a cell global identity (CGI), and transfers the current location information to the country code and the area code of the current location. For example, the PLMN consists of a Mobile Country Code (MCC) and a Mobile Network Code (MNC), and the CGI consists of a mobile country code, a mobile network code, a location area code (LAC) and a cell identity (CI). Therefore, the processing unit 120 may obtain a mobile country code of the current location through the PLMN, and obtain the information of the current location of the call device through the CGI, therefore to obtain the area code of the current location, or use the CGI to obtain the area code corresponding to the current location.

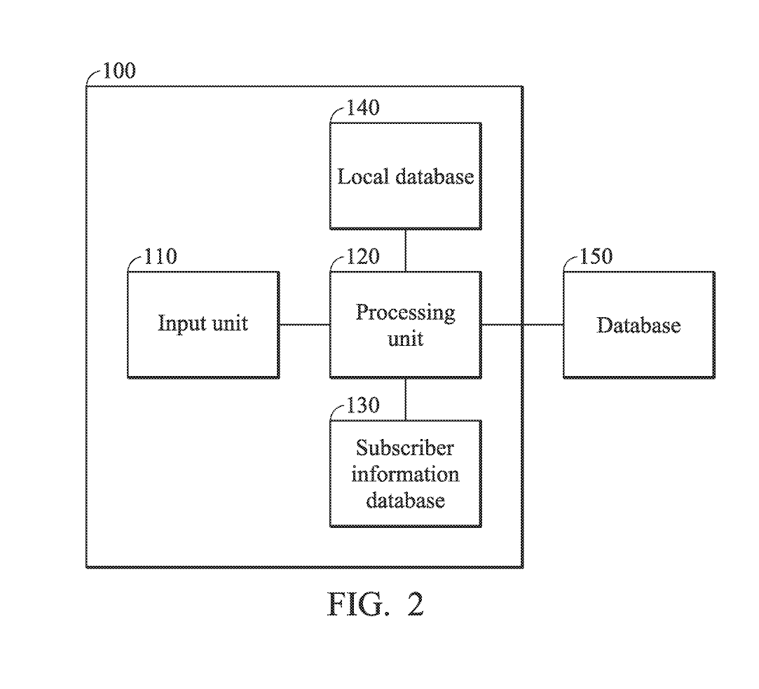

It should be noted that the telephone dialing device 100 may further comprise a local database 140, and the telephone dialing device 100 may be connected to a database 150 via a wireless communication manner, as shown in FIG. 2. The local database 140 records the relationship between the PLMN and the MCC of the network. The database 150 stores a coding rule for the country code and the area code of the current location. In one embodiment, the database 150 is a network database which may be accessed wirelessly by the telephone dialing device 100, but the invention is not limited to this example. Therefore, the processing unit 120 may obtain a mapping relation between the CGI and the area code. When the operator expends or adjusts the network, the operator may directly update the content stored in the database 150.

In another embodiment, when the current network is not available, the processing unit 120 may temporarily store related information comprising the country code, the CGI, and other information in the subscriber information database, and then perform the ensuing matters until the telephone dialing device 100 is connected to the network.

In addition, the acquisition manner also can be that the processing unit 120 obtains a line connection number via a connected line identification presentation (COLP). After obtaining the line connection number, the processing unit 120 removes the country code of the line connection number and obtains the area code of the current location according to the line connection number and the subscriber number dialed by the user.

Back to FIG. 1, if the processing unit 120 determines that the beginning of the subscriber number is an international call prefix corresponding to the country code of the current location, the processing unit 120 replaces the international call prefix of the subscriber number with the international call identification symbol “+” to produce the complete number corresponding to the subscriber number, and records the complete number in the subscriber information database 130.

If the processing unit 120 determines the beginning of the subscriber number is not the international call prefix corresponding to the international call prefix of the current location, the processing unit 120 records the country code of the current location as a country code of the subscriber number, and determines whether the subscriber number comprises an area code. If the subscriber number comprises the area code, the processing unit 120 adds the country code of the current location including the international call identification symbol “+” into the subscriber number to produce the complete number corresponding to the subscriber number, and records the complete number in the subscriber information database 130. Otherwise, the processing unit 120 adds the country code including the international call identification symbol “+” and the area code of the current location into the subscriber number to produce the complete number corresponding to the subscriber number, and records the complete number in the subscriber information database 130.

In addition, the processing unit 120 also obtains related information corresponding to the subscriber number according to the coding rule stored in the database 150 besides the subscriber number and the complete number corresponding the subscriber number, and records the related information in the subscriber information database 130, wherein the related information corresponding to the subscriber number at least comprises a number including the country code and the area code of the current location, a number which does not include the country code of the current location but includes the area code of the current location, and a number which does not include the country code and the area code of the current location.

In another embodiment, when the call device receives an incoming call, the processing unit 120 obtains a subscriber number of the incoming call through a call line identification presentation (CLIP). The processing unit 120 obtains the country code and the area code of the current location according to the coding rule and the subscriber number to produce the complete number corresponding to the subscriber number, and records the complete number in the subscriber information database 130.

In addition, the processing unit 120 may further comprise a counting unit (not shown) coupled to the processing unit 120. When the call device is successfully connected to the subscriber number, the counting unit counts the duration of the call. When the duration of the call is less than a predetermined call value, i.e., 10 seconds, the processing unit 120 does not record the complete number corresponding to the subscriber in the subscriber information database 130 to avoid the situation that the user dials an incorrect number which is wrong but still can be connected to.

The second part: the user dials a phone number corresponding to the complete number.

When the user dials a phone number, the telephone dialing device 100 can automatically add the country code and/or the area code to the phone number, or modify the phone number appropriately according to the current situation to help the user dial the phone number quickly and accurately if the phone number is one of the numbers in the related information of the subscriber umber (i.e., the complete number and the related information corresponding to the phone number are stored in the subscriber information database 130). Details are explained in the following description.

The user dials a phone number using the processing unit 120. The processing unit 120 determines whether the beginning of the phone number is the international call prefix of the current location of the call device or the international call identification symbol “+”. If the processing unit 120 determines the beginning of the phone number is the international call prefix of the current location of the call device or the international call identification symbol “+”, the processing unit 120 dials the phone number directly. If the processing unit 120 determines the beginning of the phone number is not the international call prefix of the current location of the call device or the international call identification symbol “+”, the processing unit 120 determines whether the country code of the phone number is country code of the current location. When the processing unit 120 determines the country code of the phone number is the country code of the current location, the processing unit 120 dials the phone number directly. Otherwise, the processing unit 120 further determines whether the phone number comprises the area code of the current location. If the processing unit 120 determines the phone number includes the area code of the current location, the processing unit 120 adds the international call identification symbol “+” and the country code of the subscriber into the beginning of the phone number, and dials the added phone number. If the processing unit 120 determines the phone number does not include the area code of the current location, the processing unit 120 adds the international call identification symbol “+” and the country code of the subscriber and the area code of the subscriber into the beginning of the phone number, and dials the added phone number.

It should be noted that the processing unit 120 may prompt the user to confirm whether to dial the processed phone number in the determining procedure described above. In another embodiment, the processing unit 120 may use a pop-up dialog box to prompt the user using the telephone dialing device 100, but the invention is not limited to this embodiment.

In one embodiment, when the processing unit 120 determines the phone number dialed by the user needs to be modified, the processing unit 120 may ask the user to confirm a request. In one embodiment, the processing unit 120 may use a pop-up dialog box to ask the user. In the pop-up dialog box, the user can determine that the processing unit 120 shall not use the pop-up dialog box next time. In addition, when the user determines to dial the original phone number, the processing unit 120 may clear the complete number corresponding to the phone number recorded in the subscriber information database 130.

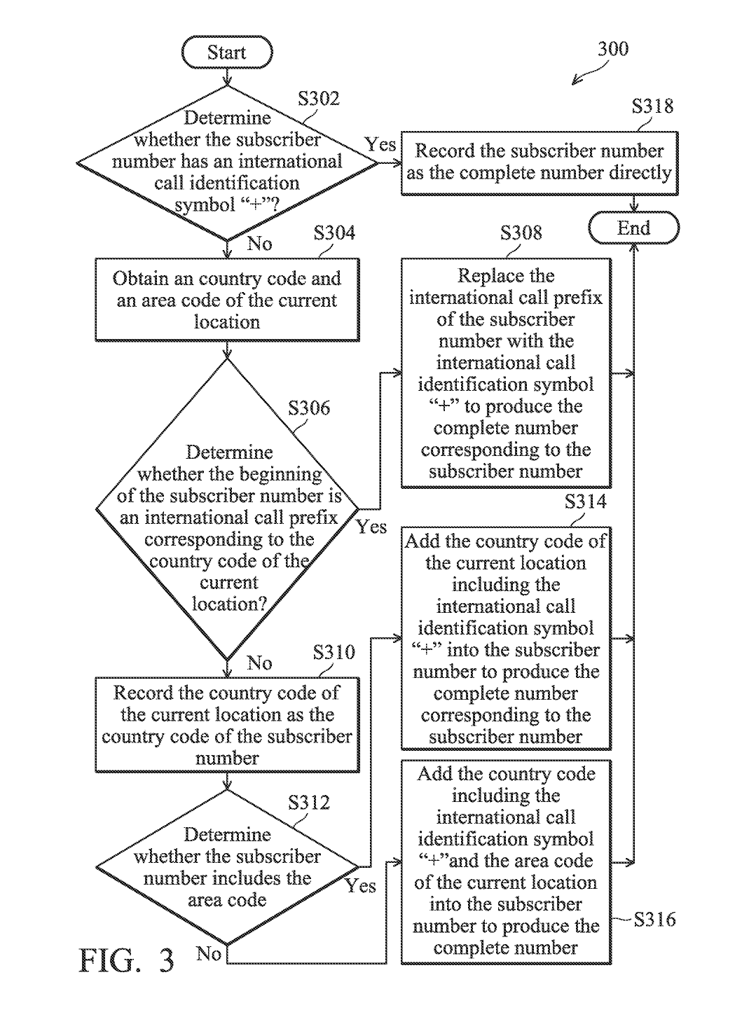

FIG. 3 is a flow diagram illustrating a method 300 for obtaining a complete number corresponding to a subscriber number according to an embodiment of the present invention. First, after the processing unit receives the subscriber number transmitted from the input unit, in step S302, the processing unit determines whether the subscriber number has an international call identification symbol “+”. If the subscriber number does not have the international call identification symbol “+” (“No” in step S302), in step S304, the processing unit obtains an country code and an area code of the current location. Then, In step S306, the processing unit determines whether the beginning of the subscriber number is an international call prefix corresponding to the country code of the current location. If the beginning of the subscriber number is the international call prefix corresponding to the country code of the current location (“Yes” in step S306), in step S308, the processing unit replaces the international call prefix of the subscriber number with the international call identification symbol “+” to produce the complete number. If the beginning of the subscriber number is not the international call prefix corresponding to the country code of the current location (“No” in step S306), in step S310, the processing unit records the country code of the current location as the country code of the subscriber number. In step S312, the processing unit determines whether the subscriber number includes the area code. If the processing unit determines the subscriber number includes the area code (“Yes” in step S312), in step S314, the processing unit adds the country code of the current location including the international call identification symbol “+” into the subscriber number to produce the complete number corresponding to the subscriber number. If the subscriber number does not include the area code (“No” in step S312), in step S316, the processing unit adds the country code including the international call identification symbol “+” and the area code of the current location into the subscriber number to produce the complete number. Back to step S302, if the subscriber number comprises the international call identification symbol “+” (“Yes” in step S302), in step S318, the processing unit records the subscriber number as the complete number directly.

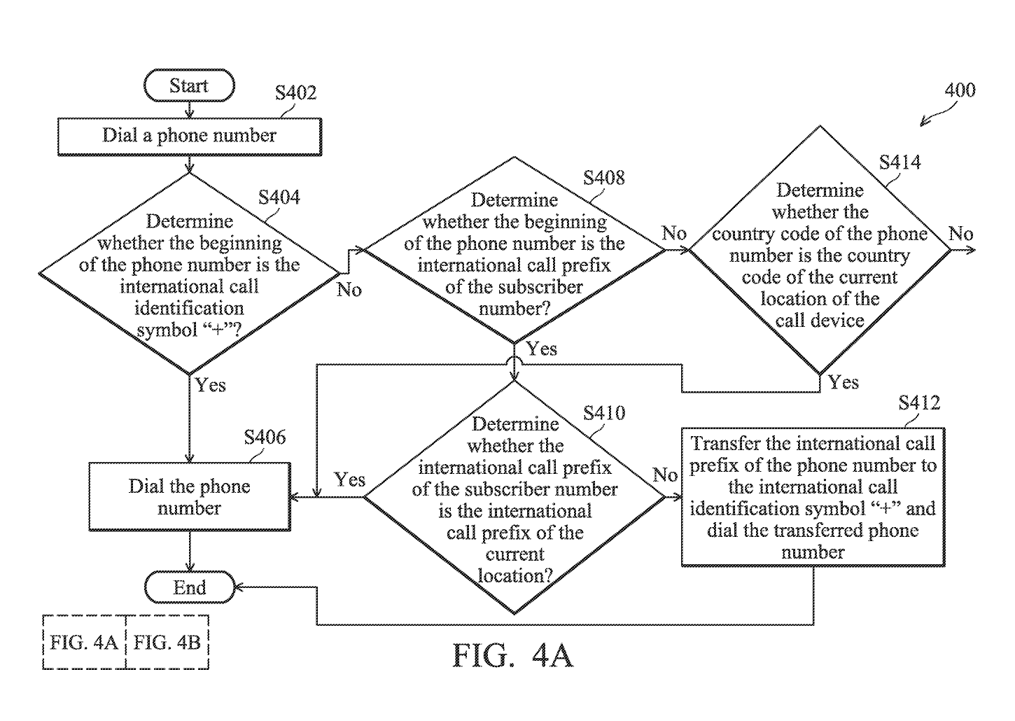

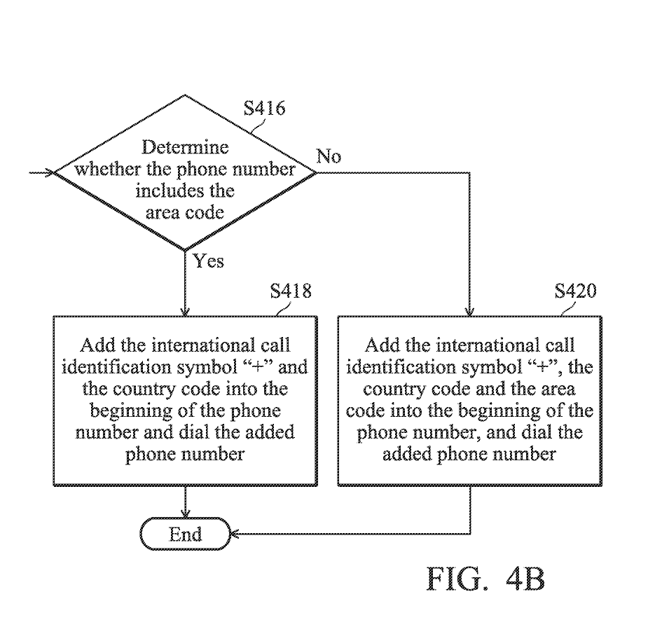

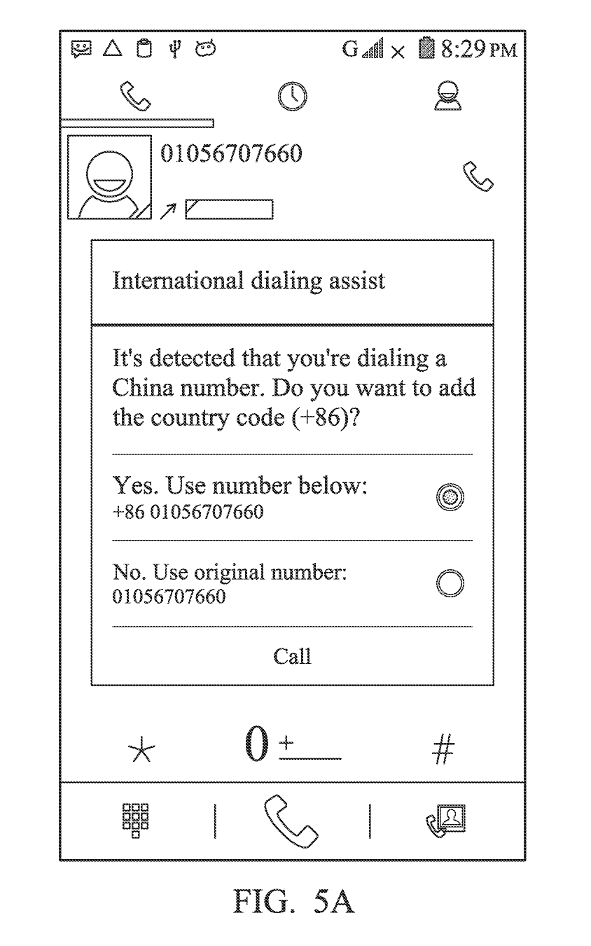

FIGS. 4A˜4B are flow diagrams illustrating a method 400 for checking and modifying a phone number dialed by a user according to one embodiment of the present invention. First, in step S402, the user dials a phone number by a call device, wherein the phone number is one of numbers in the related information corresponding to the subscriber number. Then, in step 404, the processing unit determines whether the beginning of the phone number is the international call identification symbol “+”. If so, in step S406, the processing unit dials the phone number. Otherwise, in step S408, the processing unit determines whether the beginning of the phone number is the international call prefix of the subscriber number. If so, in step S410, the processing unit determines whether the international call prefix of the subscriber number is the international call prefix of the current location. If so, in step S406, the processing unit dials the phone number. Otherwise, in step S412, the processing unit transfers the international call prefix of the phone number to the international call identification symbol “+” and dials the transferred phone number, and the flow is finished.

Back to step S408, when the beginning of the phone number is not the international call prefix of the subscriber number (“No” in step S408), in step S414, the processing unit determines whether the country code of the phone number is the country code of the current location of the call device. If so, in step S406, the processing unit dials the phone number. Otherwise, in step S416, the processing unit determines whether the phone number includes the area code. If so, in step S418, the processing unit adds the international call identification symbol “+” and the country code into the beginning of the phone number and dials the added phone number, and the flow is finished. Otherwise, in step S420, the processing unit adds the international call identification symbol “+”, the country code and the area code into the beginning of the phone number, and dials the added phone number, and the flow is finished.

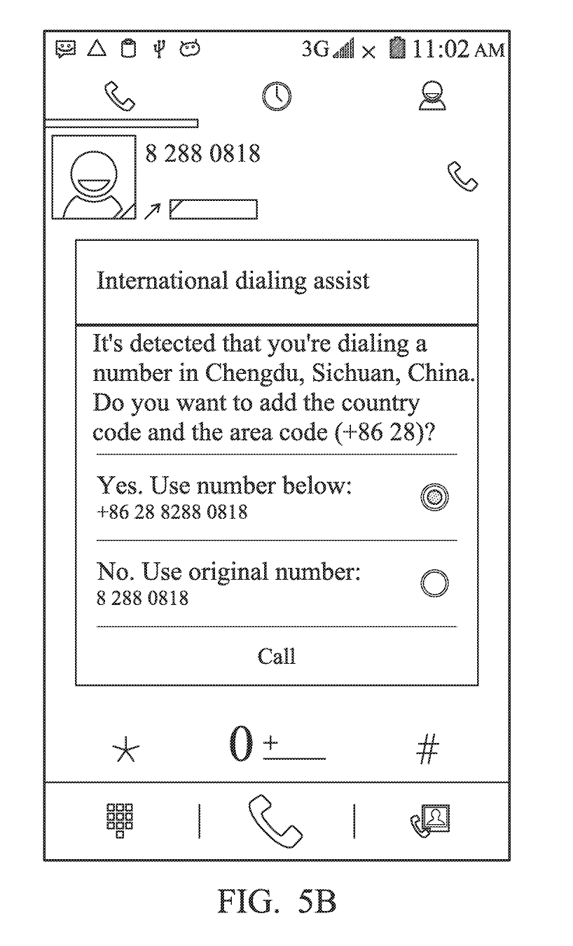

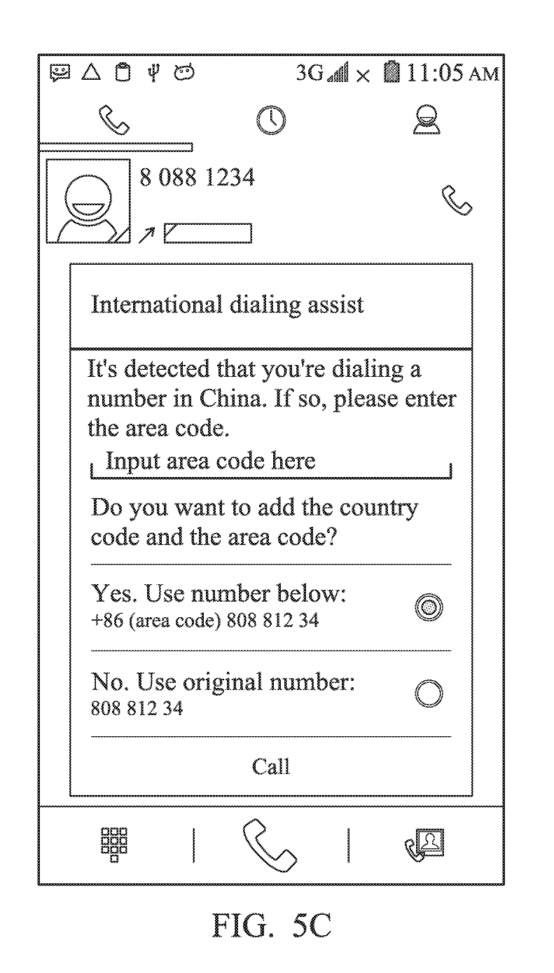

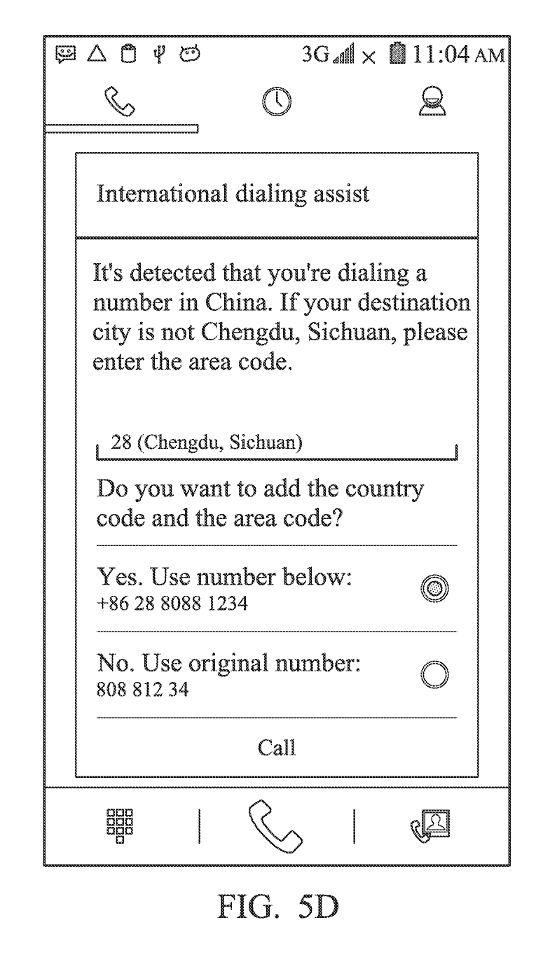

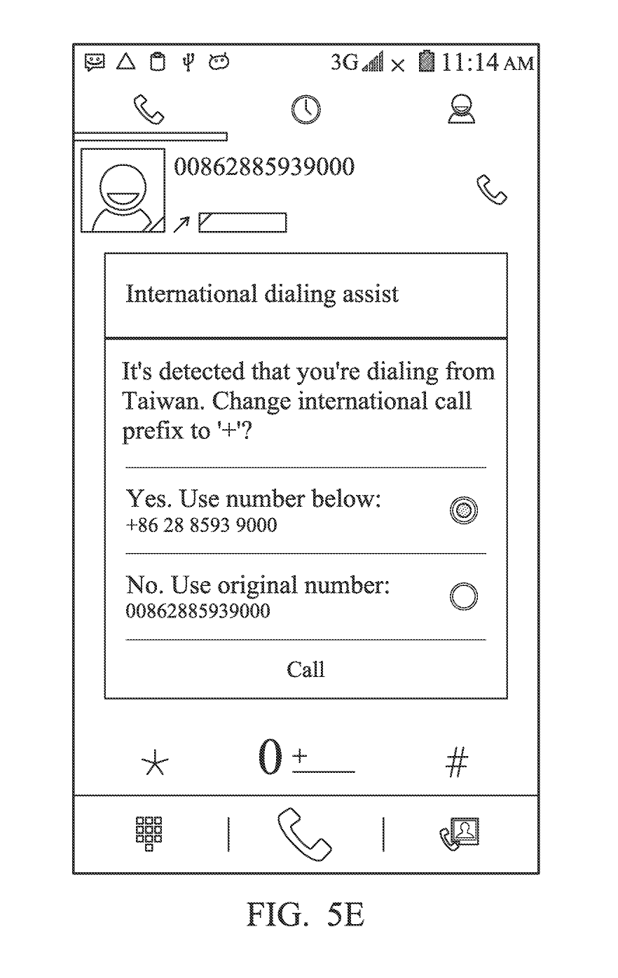

FIGS. 5A˜5E are schematic diagrams for producing a pop-up dialog box to request the user to confirm whether the dialed phone number is correct according to one exemplary embodiment of the present invention. As shown in FIG. 5A, when the user is in other countries except for China, the processing unit determines a phone number belongs to China's phone number according to the method of FIGS. 4A˜4B if the phone number inputted by the user is 01056707660. Then, the processing unit uses a pop-up dialog box to request the user to determine whether to add the international call identification symbol “+” and the country code of China (86) into the phone number. In one example, when the phone number inputted by the user does not include the country code and the area code, and the international call identification symbol “+”, the country (86) and the area code (28) corresponding to the phone number is stored in the subscriber information database, the processing unit produces the pop-up dialog box to request the user for determining whether to add the international call identification symbol, the country code and the area code into the phone number, as shown in FIG. 5B. However, if the subscriber information database only records the international call identification symbol and the country code (+86) corresponding to the phone number, the processing unit produces the pop-up dialog box to request the user for determining whether to input the area code into the phone number or dial the phone number, as shown in FIG. 5C. Also, the processing unit may produce the pop-up dialog box to remind the user of the area code which should be added in the phone number, as shown in FIG. 5D. In another example, the processing unit can also produce the pop-up dialog box to ask the user to confirm whether to modify the international call prefix to the international call identification symbol “+”, as shown in FIG. 5E.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The above-described embodiments of the present invention can be implemented in any of numerous ways. For example, the embodiments may be implemented using hardware, software or a combination thereof. It should be appreciated that any component or collection of components that perform the functions described above can be generically considered as one or more processors that control the above discussed function. The one or more processors can be implemented in numerous ways, such as with dedicated hardware, or with general-purpose hardware that is programmed using microcode or software to perform the functions recited above.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A telephone dialing device for automatic conversion, comprising:
an input unit, receiving a subscriber number after a call device makes a call or answers the call corresponding to the subscriber number successfully;
a processing unit, coupled to the input unit and performing a conversion process for converting the subscriber number into a complete number; and
a subscriber information database, coupled to the processing unit and is used for storing the complete number corresponding to the subscriber.

2. The telephone dialing device for automatic conversion as claimed in claim 1, wherein when the call device dials a phone number corresponding to the subscriber, the processing unit processes the phone number according to a country code and/or an area code of a current location of the call device and the complete number to provide the call device for dialing.

3. The telephone dialing device for automatic conversion as claimed in claim 1, wherein the processing unit performs the following steps to transfer the subscriber number to the complete number:
determining whether the subscriber number comprises an international call identification symbol “+”;
if the subscriber number comprises the international call identification symbol “+”, the processing unit records the subscriber number as the complete number;
if the subscriber number does not comprise the international call identification symbol “+”, the processing unit obtains a country code and an area code of a current location of the call device, and determines whether the beginning of the subscriber number is an international call prefix corresponding to the country code of the current location;
if the beginning of the subscriber number is the international call prefix, the international call prefix of the subscriber number is replaced with the international call identification symbol “+” to produce the complete number; and
if the beginning of the subscriber number is not the international call prefix, the processing unit records the country code of the current location as a country code of the subscriber number, and determines whether the subscriber number comprises an area code;
if the subscriber number comprises the area code, the processing unit adds the country code of the current location including the international call identification symbol “+” into the subscriber number to produce the complete number; otherwise, the processing unit adds the country code including the international call identification symbol “+” and the area code of the current location into the subscriber number to produce the complete number.

4. The telephone dialing device for automatic conversion as claimed in claim 2, wherein the processing unit obtains current location information of the call device according to a public land mobile-communication network (PLMN) and a cell global identity (CGI) by a global positioning system (GPS) receiver, and transfers the current location information to the country code and the area code of the current location, or obtains a line connecting number by a connected line identification presentation (COLP) and obtains the area code according to the line connecting number and the subscriber number.

5. The telephone dialing device for automatic conversion as claimed in claim 3, wherein the processing unit obtains current location information of the call device according to a public land mobile-communication network (PLMN) and a cell global identity (CGI) by a global positioning system (GPS) receiver, and transfers the current location information to the country code and the area code of the current location, or obtains a line connecting number by a connected line identification presentation (COLP) and obtains the area code according to the line connecting number and the subscriber number.

6. The telephone dialing device for automatic conversion as claimed in claim 2, wherein the processing unit obtains a coding rule for the country code and the area code of the current location from a database.

7. The telephone dialing device for automatic conversion as claimed in claim 6, wherein the subscriber information database further stores related information corresponding to the subscriber number that the processing unit obtains according to the coding rule, wherein the related information corresponding to the subscriber number at least comprises:
a first number including the country code and the area code of the current location;
a second number which does not include the country code of the current location but includes the area code of the current location; and
a third number which does not include the country code and the area code of the current location.

8. The telephone dialing device for automatic conversion as claimed in claim 2, wherein the processing unit further performs the steps of:
determining whether the beginning of the phone number is an international call identification symbol “+”; and if so, dialing the phone number, otherwise, determining whether the beginning of the phone number is an international call prefix of the subscriber number;
if so, determining whether the international call prefix of the subscriber number is an international call prefix of the current location, otherwise, determining whether a country code of the phone number is the country code of the current location; and
when the international call prefix of the subscriber number is the international prefix of the current location, dialing the phone number; when the international call prefix of the subscriber number is not the international call prefix of the current location, transferring the international call prefix of the phone number to the international call identification symbol “+” and dialing the transferred phone number.

9. The telephone dialing device for automatic conversion as claimed in claim 8, wherein
when the country code of the phone number is the country code of the current location, the processing unit dials the phone number; when the country code of the phone number is not the country code of the current location, the processing unit determines whether the phone number includes the area code;
if so, the processing unit adds the international call identification symbol “+” and the country code into the beginning of the phone number, and dials the added phone number; and
otherwise, the processing unit adds the international call identification symbol “+”, the country code and the area code into the beginning of the phone number, and dials the added phone number.

10. The telephone dialing device for automatic conversion as claimed in claim 7, wherein the processing unit may further use a pop-up dialog box to prompt a user using the telephone dialing device.

11. The telephone dialing device for automatic conversion as claimed in claim 8, wherein the processing unit may further use a pop-up dialog box to prompt a user using the telephone dialing device.

12. The telephone dialing device for automatic conversion as claimed in claim 1, further comprising:
a counting unit, coupled to the processing unit and used to count a duration of the call after the processing unit connects successfully to the subscriber number,
wherein when the duration of the call is less than a predetermined call value, the processing unit does not store the complete number corresponding to the subscriber in the subscriber information database.

13. A telephone dialing method for automatic conversion, used in a call device, comprising:
receiving a subscriber number after the call device makes a call or answers the call corresponding to the subscriber number successfully;
performing a conversion process for converting the subscriber number into a complete number; and
storing the complete number corresponding to the subscriber.

14. The telephone dialing method for automatic conversion as claimed in claim 13, further comprising:
processing a phone number according to a country code and/or an area code of a current location of the call device and the complete number to provide the call device for dialing.

15. The telephone dialing method for automatic conversion as claimed in claim 13, wherein the step for transferring the subscriber number to the complete number further comprises:
determining whether the subscriber number comprises an international call identification symbol “+”;
if the subscriber number comprises the international call identification symbol “+”, recording the subscriber number as the complete number;
if the subscriber number does not comprise the international call identification symbol “+”, obtaining a country code and an area code of a current location of the call device, and determining whether the beginning of the subscriber number is an international call prefix corresponding to the country code of the current location;
if the beginning of the subscriber number is the international call prefix, the international call prefix of the subscriber number is replaced with the international call identification symbol “+” to produce the complete number;
if the beginning of the subscriber number is not the international call prefix, recording the country code of the current location as a country code of the subscriber number, and determining whether the subscriber number comprises an area code; and
if the subscriber number comprises the area code, adding the country code of the current location including the international call identification symbol “+” into the subscriber number to produce the complete number; otherwise, adding the country code including the international call identification symbol “+” and the area code of the current location into the subscriber number to produce the complete number.

16. The telephone dialing method for automatic conversion as claimed in claim 14, further comprising:
obtaining current location information of the call device according to a public land mobile-communication network (PLMN) and a cell global identity (CGI) by a global positioning system (GPS) receiver, and transferring the current location information to the country code and the area code of the current location, or obtaining a line connecting number by a connected line identification presentation (COLP) and obtaining the area code according to the line connecting number and the subscriber number.

17. The telephone dialing method for automatic conversion as claimed in claim 15, further comprising:
obtaining current location information of the call device according to a public land mobile-communication network (PLMN) and a cell global identity (CGI) by a global positioning system (GPS) receiver, and transferring the current location information to the country code and the area code of the current location, or obtaining a line connecting number by a connected line identification presentation (COLP) and obtaining the area code according to the line connecting number and the subscriber number.

18. The telephone dialing method for automatic conversion as claimed in claim 14, further comprising:
obtaining a coding rule for the country code and the area code of the current location from a database.

19. The telephone dialing method for automatic conversion as claimed in claim 18, further comprising:
obtaining related information corresponding to the subscriber number according to the coding rule, and storing the related information,
wherein the related information corresponding to the subscriber number at least comprises:
a first number including the country code and the area code of the current location;
a second number which does not include the country code of the current location but includes the area code of the current location; and
a third number which does not include the country code and the area code of the current location.

20. The telephone dialing method for automatic conversion as claimed in claim 14, further comprising:
determining whether the beginning of the phone number is an international call identification symbol “+”;
if so, dialing the phone number, otherwise, determining whether the beginning of the phone number is an international call prefix of the subscriber number;
if so, determining whether the international call prefix of the subscriber number is an international call prefix of the current location, otherwise, determining whether a country code of the phone number is the country code of the current location; and
when the international call prefix of the subscriber number is the international prefix of the current location, dialing the phone number; when the international call prefix of the subscriber number is not the international call prefix of the current location, transferring the international call prefix of the phone number to the international call identification symbol “+” and dialing the transferred phone number.

21. The telephone dialing method for automatic conversion as claimed in claim 20, wherein
when the country code of the phone number is the country code of the current location, dialing the phone number; when the country code of the phone number is not the country code of the current location, determining whether the phone number includes the area code of the current location;
if so, adding the international call identification symbol “+” and the country code into the beginning of the phone number, and dialing the added phone number; and
otherwise, adding the international call identification symbol “+”, the country code and the area code into the beginning of the phone number, and dialing the added phone number.

22. The telephone dialing method for automatic conversion as claimed in claim 20, further comprising:
using a pop-up dialog box to prompt a user using the telephone dialing method.

23. The telephone dialing method for automatic conversion as claimed in claim 21, further comprising:
using a pop-up dialog box to prompt a user using the telephone dialing method.

24. The telephone dialing method for automatic conversion as claimed in claim 13, further comprising:
counting a duration of the call after connecting successfully to the subscriber number,
wherein when the duration of the call is less than a predetermined call value, not storing the complete number corresponding to the subscriber in the subscriber information database.
